(19) United States
(12) Patent Application Publication
(10) Pub. No.: US 2020/0008639 A1
(43) Pub. Date: Jan. 9, 2020

(54) ARTIFICIAL INTELLIGENCE MONITORING DEVICE AND METHOD OF OPERATING THE SAME

(71) Applicant: LG ELECTRONICS INC., Seoul (KR)

(72) Inventors: Jaemyung LEE, Seoul (KR); Jichan MAENG, Seoul (KR)

(73) Assignee: LG ELECTRONICS INC., Seoul (KR)

(21) Appl. No.: 16/578,010

(22) Filed: Sep. 20, 2019

(30) Foreign Application Priority Data
Aug. 28, 2019 (KR) 10-2019-0106020

(51) Int. Cl. A47L 9/28; G05D 1/02; G06K 9/00; G06N 20/00

(52) U.S. Cl. CPC A47L 9/2894; A47L 9/2815; G05D 1/0246; G05D 1/0274; A47L 2201/06; G06N 20/00; G05D 2201/0203; G05D 2201/0215; A47L 2201/04; G06K 9/00664

(57) ABSTRACT

An artificial intelligence monitoring device includes a camera configured to capture an image, a communication unit configured to receive cleaning information from an artificial intelligence cleaner, and a processor configured to determine whether a floor situation is a situation in which cleaning is required, based on the image or the cleaning information, determine a cleaning area and a cleaning type upon determining that cleaning is required, and transmit a cleaning command including the determined cleaning area and cleaning type to the artificial intelligence cleaner through the communication unit.

### CROSS-REFERENCE TO RELATED APPLICATIONS

Pursuant to 35 U.S.C. § 119(a), this application claims the benefit of earlier filing date and right of priority to Korean Patent Application No. 10-2019-0106020, filed on Aug. 28, 2019, the contents of which are hereby incorporated by reference herein in its entirety.

### BACKGROUND

The present disclosure relates to an artificial intelligence monitoring device capable of monitoring a cleaning situation through artificial intelligence.

A robot cleaner is an AI device to self-drive in an area to be cleaned without an operation of a user to suction foreign substances, such as dust, from the floor, thereby automatically performing cleaning.

Such a robot cleaner sets a cleaning path by recognizing the structure of a space and performs a cleaning operation along the set cleaning path. In addition, the robot cleaner performs cleaning according to a preset schedule or a user command.

In general, such a robot cleaner performs a passive function for performing cleaning along a set cleaning path.

In addition, the conventional cleaner recognizes the situation of a floor on which the robot travels and performs cleaning when cleaning is required.

However, the conventional robot cleaner recognizes only a floor situation at a traveling position and does not recognize a floor situation at a position far from the robot cleaner. Therefore, it is impossible to immediately cope with the floor situation at the position far from the robot cleaner.

In addition, the conventional robot cleaner may finish cleaning without completing cleaning, such that cleaning is not completely performed.

### SUMMARY

The present disclosure is to provide an artificial intelligence monitoring device capable of efficiently performing cleaning, by monitoring a situation in which cleaning is required in a house.

The present disclosure is to provide an artificial intelligence monitoring device capable of performing cleaning again with respect to an incompletely cleaned portion even when an artificial intelligence device finishes cleaning.

An artificial intelligence monitoring device according to an embodiment of the present disclosure may determine whether a floor situation is a situation in which cleaning is required based on a captured image or cleaning information received from an artificial intelligence cleaner, determine a cleaning area and a cleaning type upon determining that cleaning is required, and transmit a cleaning command including the determined cleaning area and cleaning type to the artificial intelligence cleaner.

It may be determined that the floor situation of the cleaning area is a situation in which cleaning is required, when there is a cleaning area, in which a cleaning performance degree of the artificial intelligence cleaner which has performed cleaning along a predetermined movement path is less than a predetermined performance degree based on the movement path of the artificial intelligence cleaner, among a plurality of cleaning areas.

### BRIEF DESCRIPTION OF THE DRAWINGS

The present disclosure will become more fully understood from the detailed description given herein below and the accompanying drawings, which are given by illustration only, and thus are not limitative of the present disclosure, and wherein:

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4 illustrates an AI device 100 according to an embodiment of the present disclosure.

FIG. 5 a perspective view of an AI device 100 according to an embodiment of the present disclosure.

FIG. 6 a bottom view of an AI device 100 according to an embodiment of the present disclosure.

FIG. 7a is a side view of an artificial intelligence device according to another embodiment of the present disclosure, and FIG. 7b is a bottom view of the artificial intelligence device.

FIG. 8 is a ladder diagram illustrating a method of operating an artificial intelligence system according to an embodiment of the present disclosure.

FIG. 9 is a view illustrating a process of training an image recognition model according to an embodiment of the present disclosure.

FIGS. 10 to 12 are views illustrating a process of determining a cleaning area according to an embodiment of the present disclosure.

FIG. 13 is a view illustrating an example of determining a cleaning type according to an embodiment of the present disclosure.

FIGS. 14 and 15 are views illustrating operation performed after a cleaning command is transmitted to an artificial intelligence cleaner according to an embodiment of the present disclosure.

FIG. 16 is a view illustrating an example of providing information on a cleaning area and a cleaning type through a mobile terminal of a user.

FIG. 17 is a ladder diagram illustrating a method of operating an artificial intelligence system according to another embodiment of the present disclosure.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

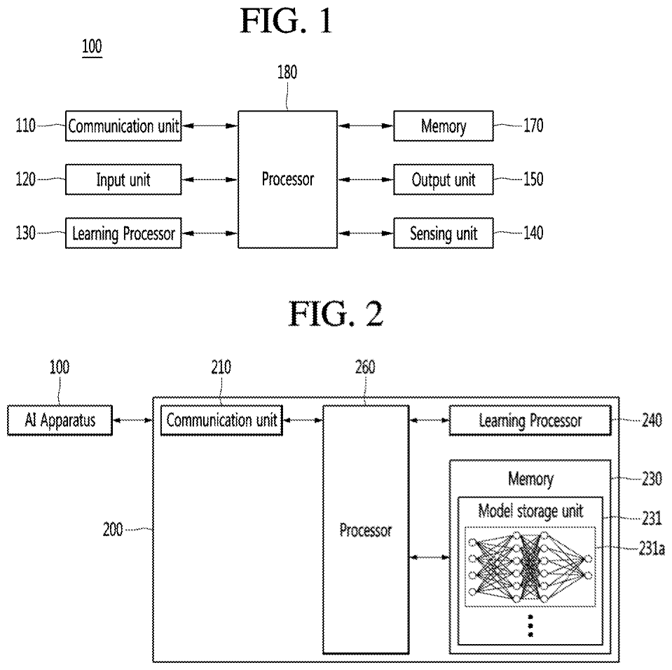

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™ RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

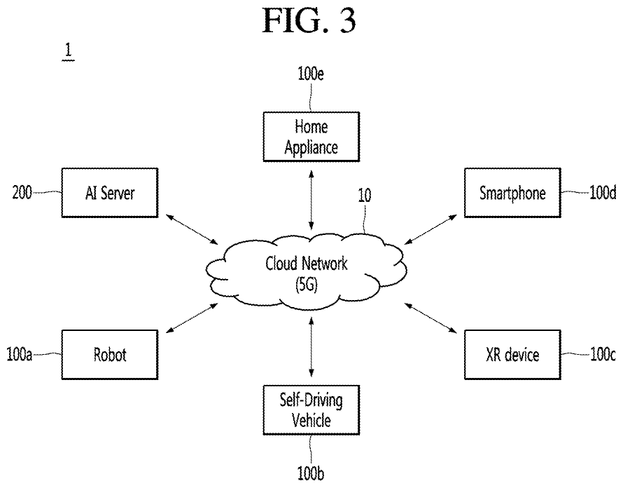

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

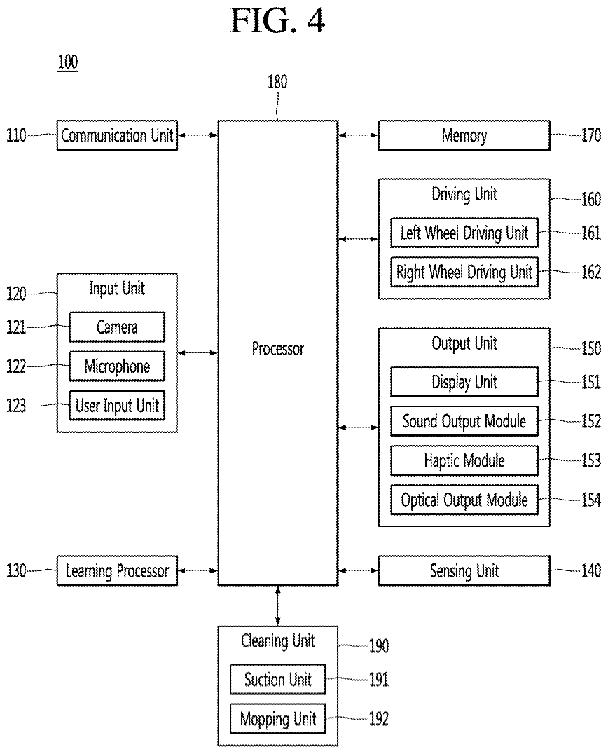

FIG. 4 illustrates an AI device 100 according to an embodiment of the present disclosure.

The redundant repeat of FIG. 1 will be omitted below.

Referring to FIG. 4, the AI device 100 may further include a driving unit 160 and a cleaning unit 190.

The input unit 120 may include a camera 121 for image signal input, a microphone 122 for receiving audio signal input, and a user input unit 123 for receiving information from a user.

Voice data or image data collected by the input unit 120 are analyzed and processed as a user's control command.

Then, the input unit 120 is used for inputting image information (or signal), audio information (or signal), data, or information inputted from a user and the mobile terminal 100 may include at least one camera 121 in order for inputting image information.

The camera 121 processes image frames such as a still image or a video obtained by an image sensor in a video call mode or a capturing mode. The processed image frame may be displayed on the display unit 151 or stored in the memory 170.

The microphone 122 processes external sound signals as electrical voice data. The processed voice data may be utilized variously according to a function (or an application program being executed) being performed in the mobile terminal 100. Moreover, various noise canceling algorithms for removing noise occurring during the reception of external sound signals may be implemented in the microphone 122.

The user input unit 123 is to receive information from a user and when information is inputted through the user input unit 123, the processor 180 may control an operation of the mobile terminal 100 to correspond to the inputted information.

The user input unit 123 may include a mechanical input means (or a mechanical key, for example, a button, a dome switch, a jog wheel, and a jog switch at the front, back or side of the mobile terminal 100) and a touch type input means. As one example, a touch type input means may include a virtual key, a soft key, or a visual key, which is displayed on a touch screen through software processing or may include a touch key disposed at a portion other than the touch screen.

The sensing unit 140 may be called a sensor unit.

The sensing unit 140 may include at least one of a depth sensor (not illustrated) or an RGB sensor (not illustrated) to acquire image data for a surrounding of the AI robot 100.

The depth sensor may sense that light irradiated from the light emitting unit (not illustrated) is reflected and return. The depth sensor may measure the difference between times at which the returning light is transmitted, an amount of the returning light, and a distance from an object.

The depth sensor may acquire information on a two dimensional image or a three dimensional image of the surrounding of the AI robot 100, based on the distance from the object.

The RGB sensor may obtain information on a color image for an object or a user around the AI robot 100. The information on the color image may be an image obtained by photographing an object. The RGB sensor may be named an RGB camera.

In this case, the camera 121 may refer to the RGB sensor.

The output unit 150 may include at least one of a display unit 151, a sound output module 152, a haptic module 153, or an optical output module 154.

The display unit 151 may display (output) information processed in the mobile terminal 100. For example, the display unit 151 may display execution screen information of an application program running on the mobile terminal 100 or user interface (UI) and graphic user interface (GUI) information according to such execution screen information.

The display unit 151 may be formed with a mutual layer structure with a touch sensor or formed integrally, so that a touch screen may be implemented. Such a touch screen may serve as the user input unit 123 providing an input interface between the mobile terminal 100 and a user, and an output interface between the mobile terminal 100 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user can feel. A representative example of a haptic effect that the haptic module 153 generates is vibration.

The optical output module 154 outputs a signal for notifying event occurrence by using light of a light source of the mobile terminal 100. An example of an event occurring in the mobile terminal 100 includes message reception, call signal reception, missed calls, alarm, schedule notification, e-mail reception, and information reception through an application.

The driving unit 160 may move the AI robot 100 in a specific direction or by a certain distance.

The driving unit 160 may include a left wheel driving unit 161 to drive the left wheel of the AI robot 100 and a right wheel driving unit 162 to drive the right wheel.

The left wheel driving unit 161 may include a motor for driving the left wheel, and the right wheel driving unit 162 may include a motor for driving the right wheel.

Although the driving unit 160 includes the left wheel driving unit 161 and the right wheel driving unit 162 by way of example as in FIG. 4, but the present disclosure is not limited thereto. In other words, according to an embodiment, the driving unit 160 may include only one wheel.

The cleaning unit 190 may include at least one of a suction unit 191 or a mopping unit 192 to clean the floor around the AI device 100.

The suction unit 191 may be referred to as a vacuum cleaning unit.

The suction unit 191 may suction air to suction foreign matters such as dust and garbage around the AI device 100.

In this case, the suction unit 191 may include a brush or the like to collect foreign matters.

The mopping unit 192 may wipe the floor in the state that a mop is at least partially in contact with the bottom surface of the AI device 100.

In this case, the mopping unit 192 may include a mop and a mop driving unit to move the mop

In this case, the mopping unit 192 may adjust the distance from the ground surface through the mop driving unit. In other words, the mop driving unit may operate such that the mop makes contact with the ground surface when the mopping is necessary.

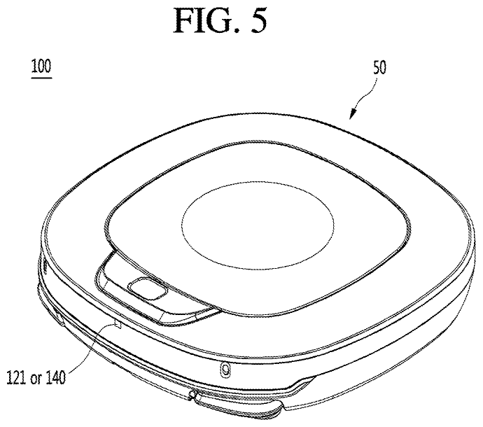

FIG. 5 a perspective view of the AI device 100 according to an embodiment of the present disclosure.

Referring to FIG. 5, the AI robot 100 may include a cleaner body 50 and a camera 121 or a sensing unit 140.

The camera 121 or the sensing unit 140 may irradiate a light forward and receive the reflected light.

The camera 121 or the sensing unit 140 may acquire the depth information using the difference between times at which the received lights are returned.

The cleaner body 50 may include remaining components except the camera 121 and the sensing unit 140 described with reference to FIG. 4.

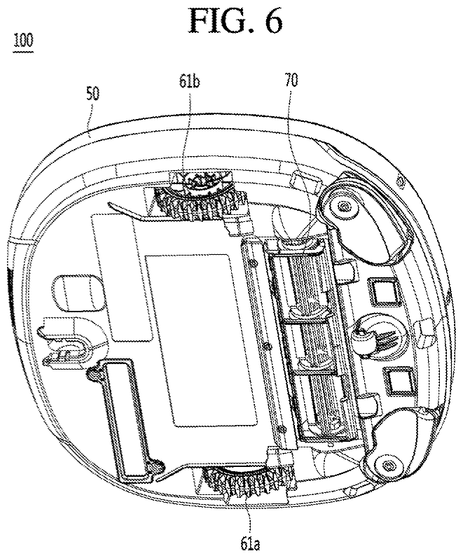

FIG. 6 is a bottom view of the AI device 100 according to an embodiment of the present disclosure.

Referring to 6, the AI device 100 may further include a cleaner body 50, a left wheel 61a, a right wheel 61b, and a suction unit 70 in addition to the components of FIG. 4.

The left wheel 61a and the right wheel 61b may allow the cleaner body 50 to travel.

The left wheel driving unit 161 may drive the left wheel 61a and the right wheel driving unit 162 may drive the right wheel 61b.

As the left wheel 61a and the right wheel 61b are rotated by the driving unit 160, the AI robot 100 may suction foreign matters such as dust and garbage through the suction unit 70.

The suction unit 70 is provided in the cleaner body 50 to suction dust on the floor surface.

The suction unit 70 may further include a filter (not illustrate) to collect foreign matters from the sucked air stream and a foreign matter receiver (not illustrated) to accumulate foreign matters collected through the filter.

In addition to the components of FIG. 4, the AI robot 100 may further include a mopping unit (not illustrated).

The mopping unit (not illustrated) may include a damp cloth (not illustrated) and a motor (not illustrated) to rotate the damp cloth in contact with the floor and to move the damp cloth along a set pattern.

The AI device 100 may wipe the floor with the mopping unit (not illustrated).

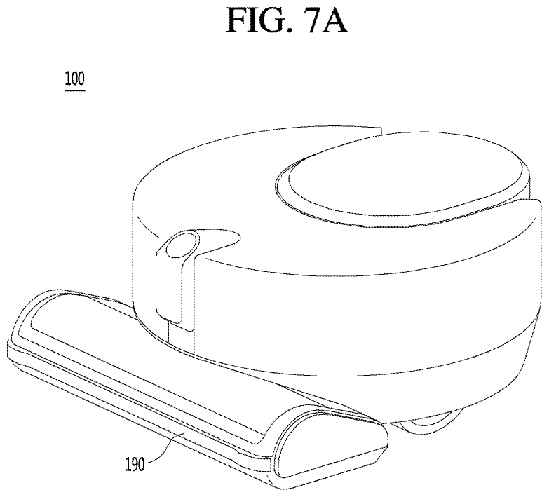

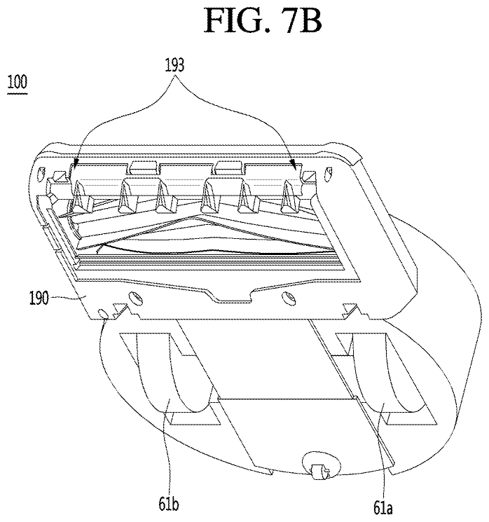

FIG. 7a is a side view of an artificial intelligence device according to another embodiment of the present disclosure, and FIG. 7b is a bottom view of the artificial intelligence device.

Hereinafter, the artificial intelligence device 100 may be referred to as a robot cleaner.

Referring to FIGS. 7a and 7b, the robot cleaner 100 may further include a bumper 190 in addition to the components of FIG. 4.

The bumper 190 may be provided at the lower end of the main body of the robot cleaner 100. The bumper 190 may include a cleaning unit 190 including the suction unit 191 and the mopping unit 192 shown in FIG. 4.

The bumper 190 may mitigate impact applied to the main body due to collision with an obstacle or another object while the robot cleaner 100 travels.

The bumper 190 may include one or more bumper sensors (not shown). The bumper sensor may measure the amount of impact applied to the bumper 190.

The bumper sensor may generate a bumper event when a predetermined amount or more of impact is detected. The bumper event may be used to detect a stuck situation of the robot cleaner 100.

In addition, each of the left wheel 61a and the right wheel 61b may include a wheel sensor. The wheel sensor may be an optical sensor for measuring the amount of rotation of the left wheel or the right wheel. The amount of rotation of the left wheel or the right wheel measured through the wheel sensor may be used to calculate the movement distance of the robot cleaner 100.

One or more cliff sensors 193 may be provided at the lower surface of the bumper 190. The cliff sensor 193 measures a distance between the floor and the cliff sensor 193 using a transmitted infrared signal and a reflected infrared signal.

The processor 180 may determine that the robot cleaner 100 reaches a staircase or a cliff when the measured distance is equal to or greater than a certain distance or when the reflected infrared signal is not detected for a certain time.

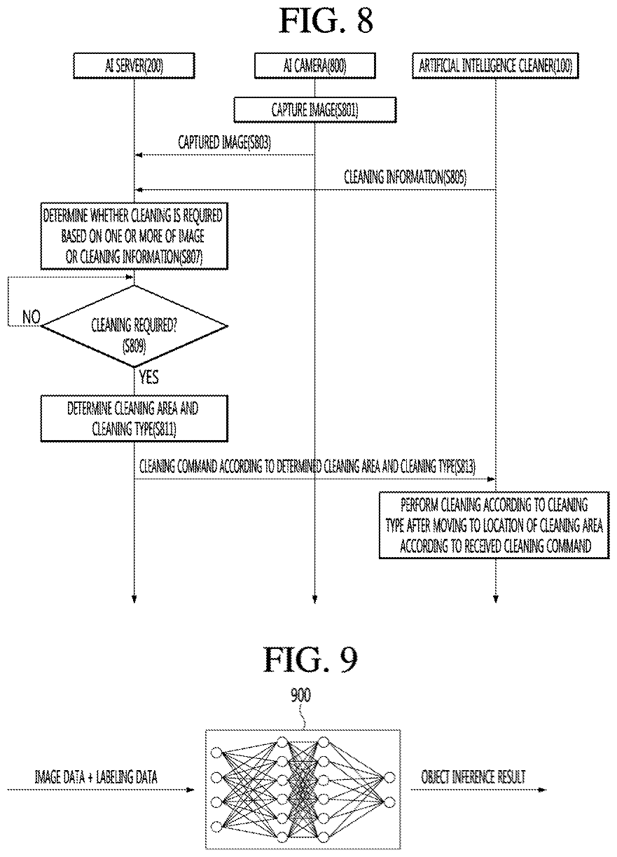

FIG. 8 is a ladder diagram illustrating a method of operating an artificial intelligence system according to an embodiment of the present disclosure.

The artificial intelligence system according to the embodiment of the present disclosure may include an artificial intelligence cleaner, an AI camera 800 and an AI server.

In particular, the AI camera 800 and the artificial intelligence cleaner may be provided in the house. Of course, the AI server 200 may also be provided in the house.

One or more artificial intelligence cleaners may be provided. One or more AI camera 800 may be provided. The AI camera 800 may include all the components of FIG. 1.

In addition, in some cases, the AI camera 800 may perform all the functions of the AI server 200.

The artificial intelligence device 100 described with reference to FIGS. 1 to 7b may be referred to as an artificial intelligence cleaner.

The AI camera 800 captures the image of the inside of the house (S801).

The AI camera 800 may periodically capture the image of the inside of the house.

A plurality of AI cameras 800 may be installed in the house. For example, the AI camera 800 may be disposed in each of a plurality of cleaning areas configuring the inside of the house.

The AI camera 800 transmits the captured image to the AI server 200 (S803).

The artificial intelligence cleaner 100 transmits collected cleaning information to the AI server 200 (S805).

In one embodiment, the cleaning information may be information on cleaning performed by the artificial intelligence cleaner 100.

The cleaning information may include one or more of the usage history of the artificial intelligence cleaner 100 or the movement path of the artificial intelligence cleaner 100.

The usage history of the artificial intelligence cleaner 100 may include a time from a time point when the artificial intelligence cleaner 100 starts operation to a time point when the artificial intelligence cleaner ends operation.

The movement path of the artificial intelligence cleaner 100 may indicate a path along which the artificial intelligence cleaner 100 moves within an operation time.

The processor 260 of the AI server 200 determines whether a current floor situation is a situation in which cleaning is required based on one or more of the image received from the AI camera 800 or the cleaning information received from the artificial intelligence cleaner 100 (S807).

The processor 260 may identify an object located on the floor from the received image based on an image recognition model.

The image recognition model may be an artificial neural network based model trained through a deep learning algorithm or a machine learning algorithm.

The image recognition model may be trained through supervised learning.

The image recognition mode may be trained by the learning processor 240 of the AI server 200 or the processor 260.

The processor 260 may determine whether the current floor situation is a situation cleaning is required, based on the inference result of the image recognition model.

The image recognition model may be a model for inferring an object placed on the floor and the state type of the object, from image data.

The image recognition model may be described with reference to FIG. 9.

FIG. 9 is a view illustrating a process of training an image recognition model according to an embodiment of the present disclosure.

A training data set for training the image recognition model may include image data for training and labeling data which is correct answer data.

The labeling data may include an identifier of an object. The identifier of the object is data for identifying the object and may include one or more of a name of the object or a state type of the object.

The state type of the object may indicate whether the object is a solid or liquid.

The image data for training may indicate an image including the object placed on the floor.

An input feature vector may be extracted from the image data for training and input to the image recognition model 900.

The image recognition model 900 may extract a target feature vector (or a target feature point) which is the inference result indicating which object is located, from the input feature vector.

The image recognition model 900 may be trained to minimize a cost function corresponding to a difference between the labeling data and the target feature vector.

The model parameters of the image recognition model 900 may be determined to minimize the cost function.

FIG. 8 will be described again.

The processor 260 may determine that the current floor situation is a situation in which cleaning is required, when the name and state type of the identified object matches those of a predetermined object as the inference result of the image recognition model 900. The predetermined object may be any one of liquid milk, liquid water or solid powder.

In another embodiment, the processor 260 may determine whether the current floor situation is a situation in which cleaning is required according to the result of comparing the received image with a reference image.

The memory 230 of the AI server 200 may receive an image before the object is placed on the floor from the AI camera 800 and store the image.

The processor 260 may compare the stored image with an image captured at the same location and received newly, detecting change in the floor state.

The processor 260 may check the size or shape of a foreign material through comparison between the stored image and the newly received image. The processor 260 may determine that the current floor situation is a situation in which cleaning is required, when the size of the foreign material is equal to or greater than a predetermined size.

In another example, the processor 260 may determine whether cleaning is required based on the cleaning information received from the artificial intelligence cleaner 100.

For example, the processor 260 may determine whether cleaning is required based on the usage history of the artificial intelligence cleaner 100. The processor 260 may determine that cleaning is required, when the artificial intelligence cleaner 100 does not operate during a predetermined time.

The processor 260 may determine that the floor situation of an incompletely cleaned area of a plurality of cleaning areas is a situation in which cleaning is required, based on the movement path of the artificial intelligence cleaner 100.

For example, when a cleaning performance degree of the artificial intelligence cleaner 100 in any one of the plurality of cleaning areas is less than a predetermined performance degree, the processor 260 may determine that the floor situation of the area is a situation in which cleaning is required.

The predetermined performance degree may be 70% but this is merely an example.

The processor 260 may determine the cleaning performance degree of the area based on the movement path of the artificial intelligence cleaner 100. For example, the processor 260 may determine how far the artificial intelligence cleaner 100 has moved on the predetermined movement path of the area as the cleaning performance degree.

The processor 260 may determine that the floor situation of the area is a situation in which cleaning is required, when the artificial intelligence cleaner 100 has moved by only 60% of the total movement path of the area.

The processor 260 of the AI server 200 determines a cleaning area and a cleaning type based on one or more of the image or the cleaning information (S811), upon determining that the current floor situation is a situation in which cleaning is required (S809).

The processor 260 may determine an area in which the object is identified as the cleaning area and determine the cleaning type according to the state of the object, upon determining that cleaning is required based on the image received from the AI camera 800.

For example, the processor 260 may determine a mopping type as the cleaning type, when the state of the object is a liquid state. The processor 260 may determine a dust suction type as the cleaning type, when the state of the object is a solid.

That is, the cleaning type may indicate whether the floor will be cleaned through dust suction or mopping.

The processor 60 may determine an additional area other than the area, in which the object is identified, as the cleaning area. The additional area may be an area obtained by excluding the area, in which the object is identified, from an area in which the main body of the artificial intelligence cleaner 100 is formed.

Meanwhile, the processor 260 may determine an area in which cleaning is insufficient as the cleaning area, upon determining that cleaning is required based on the cleaning information. In this case, the cleaning type may be set to a dust suction type by default.

The processor 260 of the AI server 200 transmits a cleaning command for performing cleaning according to the determined cleaning area and cleaning type to the artificial intelligence cleaner 100 through the communication unit 210 (S813).

The artificial intelligence cleaner 100 performs cleaning according to the cleaning type (S815), after moving to the cleaning area according to the received cleaning command.

Hereinafter, a process of determining a cleaning area and a cleaning type will be described.

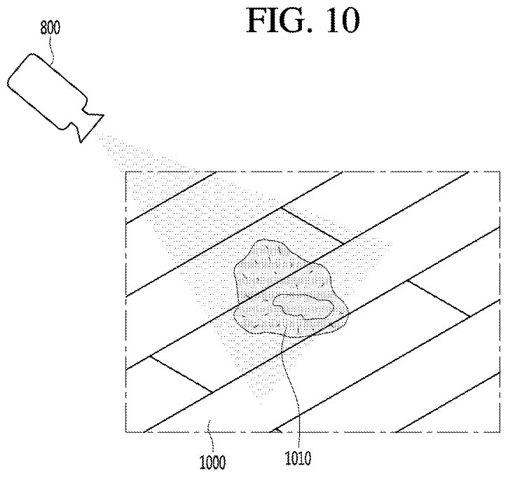

FIGS. 10 to 12 are views illustrating a process of determining a cleaning area according to an embodiment of the present disclosure.

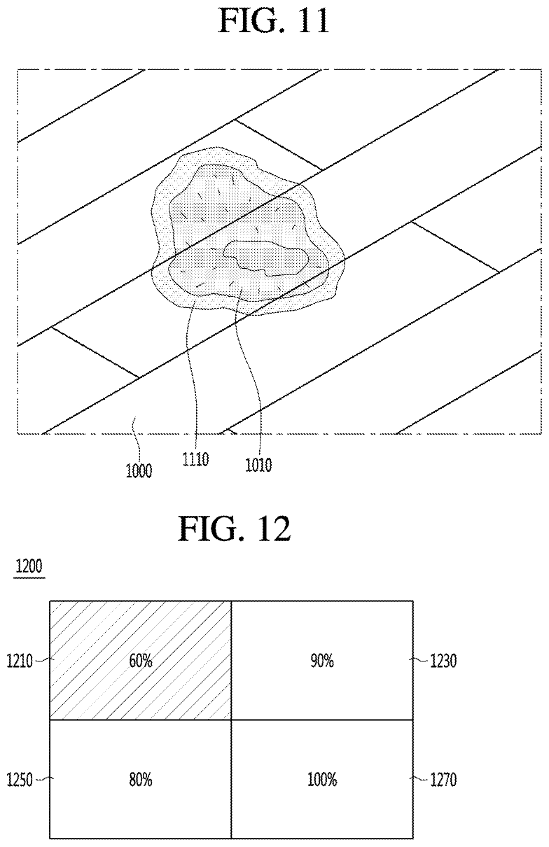

In particular, FIGS. 10 and 11 are views illustrating a process of determining a cleaning area based on an image captured using the AI camera 800, and FIG. 12 is a view illustrating a process of determining a cleaning area based on cleaning information received from the artificial intelligence cleaner 100.

First, FIGS. 10 and 11 will be described.

Referring to FIG. 10, the AI camera 800 may capture the image of the floor of the area.

The captured floor image 1000 may be transmitted to the AI server 200. The AI server 200 may identify an object from the floor image 1000 and infer the state type of the object, using the image recognition model 900.

The AI server 200 may recognize liquid milk from the floor image 1000. The AI server 200 may extract an object area 1010 occupied by the recognized liquid milk.

As shown in FIG. 11, the AI server 200 may acquire an additional area 1100 in addition to the object area 1010. The additional area 1110 may be determined in consideration of a main body area occupied by the main body of the artificial intelligence cleaner 100.

The additional area 1110 is acquired, in order to leave a margin in the object area 1010 to allow the artificial intelligence cleaner 100 to smoothly perform cleaning.

The AI server 200 may pre-store the size of the main body area of the artificial intelligence cleaner 100. The AI server 200 may determine an area obtained by subtracting the size of the object area 1010 from the size of the main body area as the additional area 1110, when the size of the object area 1010 is less than that of the main body area.

Meanwhile, the AI camera 800 may transmit the floor image 1000 and the location information of the cleaning area corresponding to the floor image to the AI server 200.

The AI server 200 may transmit a cleaning command including the received location information of the cleaning area and the cleaning type to the artificial intelligence cleaner 100.

Next, FIG. 12 will be described.

Referring to FIG. 12, a cleaning map 1200 including a plurality of cleaning areas 1210 and 1270 is shown. The cleaning map 1200 may be created by SLAM.

The AI server 200 may determine an area, in which cleaning is required, from among the plurality of cleaning areas based on the cleaning information received from the artificial intelligence cleaner 100.

The AI server 200 may acquire the cleaning performance degree in each area based on the movement path on which the artificial intelligence cleaner 100 has moved in each of the plurality of cleaning areas 1210 to 1270.

For example, the AI server 200 may acquire the cleaning performance degree of the first cleaning area 1210 of 60%, acquire the cleaning performance degree of the second cleaning area 1230 of 90%, acquire the cleaning performance degree of the third cleaning area 1250 of 80%, and acquire the cleaning performance degree of the fourth cleaning area 1270 of 100%.

Each cleaning performance degree may be determined depending on how far the cleaner has moved on the predetermined movement path in each cleaning area.

The AI server 200 may determine an area having a cleaning performance degree less than the predetermined performance degree as an area in which cleaning is required.

For example, when the predetermined performance degree is 70%, the AI server 200 may determine that the floor situation of the first cleaning area 1210 is a situation in which cleaning is required.

The AI server 200 may transmit the cleaning command including the location information of the first cleaning area 1210 and the cleaning type to the artificial intelligence cleaner 100.

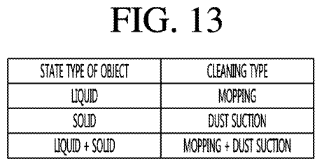

FIG. 13 is a view illustrating an example of determining a cleaning type according to an embodiment of the present disclosure.

In particular, FIG. 13 is a view showing an example of determining a cleaning type according to the determined state type of the object based on the captured image from the AI camera 800.

The AI server 200 may determine that the cleaning type is a mopping type, when the determined type of the object is a liquid type.

The AI server 200 may determine that the cleaning type is a dust suction type, when the determined type of the object is a solid type.

The AI server 200 may determine that the cleaning type is a mopping type and a dust suction type, when the determined type of the object is a liquid type and a solid type.

Meanwhile, the cleaning type may be set to a dust suction type by default, based on the cleaning information received from the artificial intelligence device 100.

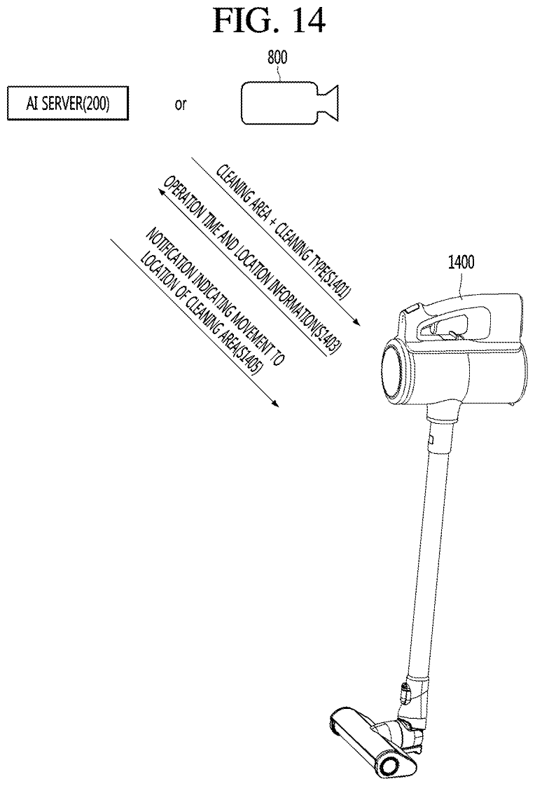

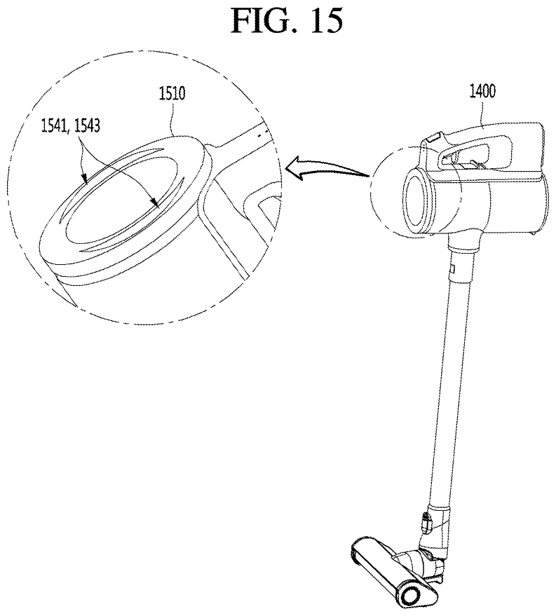

FIGS. 14 and 15 are views illustrating operation performed after a cleaning command is transmitted to an artificial intelligence cleaner according to an embodiment of the present disclosure.

In FIG. 14, assume that the artificial intelligence cleaner is a passive type vacuum cleaner 1400.

The AI server 200 or the AI camera 800 transmits the determined cleaning area and cleaning type to the vacuum cleaner 1400 (S14101).

The vacuum cleaner 1400 transmits an operation time and location information thereof during operation to the AI server 200 or the AI camera 800 when operation thereof starts (S1403).

The AI server 200 or the AI camera 800 transmits notification indicating the direction of traveling to the location of the cleaning area based on the received location information of the vacuum cleaner 1400 (S1405).

Referring to FIG. 15, the main body 1510 attached to the handle of the vacuum cleaner 1 may include one or more LEDs 1541 and 1543.

The vacuum cleaner 1400 may output the notification received from the AI server 200 or the AI camera 800 through the one or more LEDs 1541 and 1543.

For example, light may be output through the left LED 1541 when the location of the cleaning area indicates the left side of a current location and may be output through the right LED 1543 when the location of the cleaning area indicates the right side of the current location.

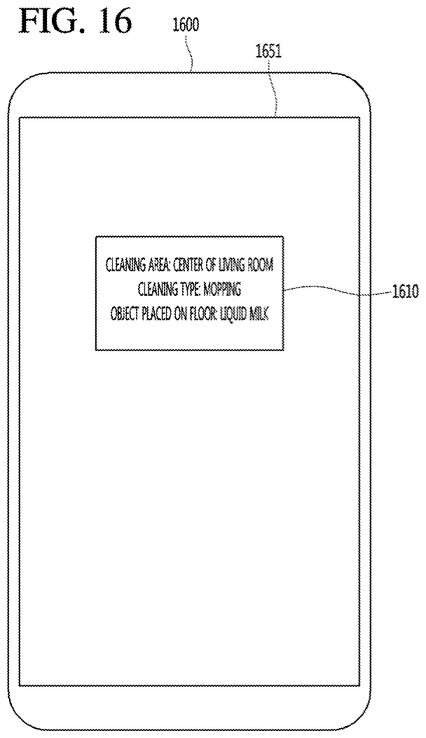

FIG. 16 is a view illustrating an example of providing information on a cleaning area and a cleaning type through a mobile terminal of a user.

The AI server 200 may transmit cleaning performance notification 1600 including the location of the determined cleaning area and the cleaning type to the mobile terminal 1600 of the user, when the cleaning area and the cleaning type are determined. The mobile terminal 1600 of the user may display the received cleaning performance notification 1600 through a display unit 1651.

The cleaning performance notification 1600 may further include the name of the identified object and the state type of the object in addition to the location of the cleaning area and the cleaning type.

The user may be rapidly notified that the floor needs to be cleaned through the cleaning performance notification 1600.

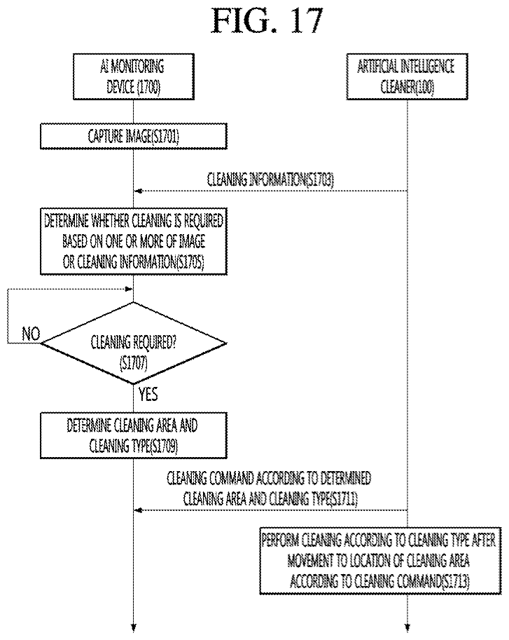

FIG. 17 is a ladder diagram illustrating a method of operating an artificial intelligence system according to another embodiment of the present disclosure.

In FIG. 17, the artificial intelligence system may include an AI monitoring device 1700 and the artificial intelligence cleaner 100.

The AI monitoring device 1700 may further include the components of the AI server 200 of FIG. 2 and a camera.

That is, the AI monitoring device 1700 may be the AI server 200 including the camera.

A plurality of AI monitoring devices 1700 may be provided in the house.

Referring to FIG. 17, the AI monitoring device 1700 captures the image of the inside of the house through the camera (S1701).

The processor 260 of the AI monitoring device 1700 receives cleaning information from the artificial intelligence cleaner 100 (S1703).

For the description of the cleaning information, refer to the description of the cleaning information of step S805.

The processor 260 of the AI monitoring device 1700 determines whether a current floor situation is a situation in which cleaning is required based on one or more of the captured image or the cleaning information received from the artificial intelligence cleaner 100 (S1705).

For determination as to whether cleaning is required, refer to the description of step S807.

The processor 260 of the AI monitoring device 1700 determines a cleaning area and a cleaning type based on one or more of the image or the cleaning information (S1709), upon determining that the current floor situation is a situation in which cleaning is required (S1707).

For the description of step S1709, refer to the description of step S811.

The processor 260 of the AI monitoring device 1700 transmits a cleaning command for performing cleaning according to the cleaning area and the cleaning type to the artificial intelligence cleaner 100 through the communication unit 210 (S1711).

For the description of step S1711, refer to the description of step S813.

The artificial intelligence cleaner 100 performs cleaning according to the cleaning type (S1713), after moving to the cleaning area according to the received cleaning command.

According to the embodiment of the present disclosure, it is possible to efficiently perform cleaning, by monitoring up to an area which is not recognized by the artificial intelligence cleaner.

According to the embodiment of the present disclosure, it is possible to perform cleaning more cleanly, by performing cleaning an incompletely cleaned portion again.

The present disclosure mentioned in the foregoing description can also be embodied as computer readable codes on a computer-readable recording medium. Examples of possible computer-readable mediums include HDD (Hard Disk Drive), SSD (Solid State Disk), SDD (Silicon Disk Drive), ROM, RAM, CD-ROM, a magnetic tape, a floppy disk, an optical data storage device, etc. The computer may include the controller 180 of the AI device.

What is claimed is:

1. An artificial intelligence monitoring device comprising:
a camera configured to capture an image;
a communication processor configured to receive cleaning information from an artificial intelligence cleaner; and
a processor configured to:
determine whether a floor situation is a situation in which cleaning is required, based on the image or the cleaning information,
determine a cleaning area and a cleaning type upon determining that cleaning is required, and
transmit a cleaning command including the determined cleaning area and cleaning type to the artificial intelligence cleaner through the communication processor.

2. The artificial intelligence monitoring device of claim 1,
wherein the memory stores an image recognition model for identifying an object from the image,
wherein the image recognition model is an artificial neural network based model subjected to supervised learning through a deep learning algorithm or a machine learning algorithm, and
wherein the processor determines that the floor situation is a situation in which cleaning is required, when a name of the identified object and a state type of the object match a predetermined name and state type.

3. The artificial intelligence monitoring device of claim 1,
wherein the cleaning information includes a usage history of the artificial intelligence cleaner, and
wherein the processor determines that the floor situation is a situation in which cleaning is required, when the artificial intelligence cleaner does not operate for a predetermined time or more.

4. The artificial intelligence monitoring device of claim 1,
wherein the cleaning information includes a movement path of the artificial intelligence cleaner, and
wherein the processor determines that the floor situation is a situation in which cleaning is required, when there is a cleaning area, in which a cleaning performance degree of the artificial intelligence cleaner which has performed cleaning along a predetermined movement path is less than a predetermined performance degree, based on the movement path among a plurality of cleaning areas.

5. The artificial intelligence monitoring device of claim 2, wherein the cleaning type includes one or more of a mopping type or a dust suction type.

6. The artificial intelligence monitoring device of claim 3,
wherein the processor:
determines that the cleaning type is a mapping type when the state type of the object is a liquid type, and
determines that the cleaning type is a dust suction type when the state type of the object is a solid type.

7. The artificial intelligence monitoring device of claim 1,
wherein the cleaning command is a command for moving the artificial intelligence cleaner to the cleaning area to perform cleaning according to the determined cleaning type.

8. The artificial intelligence monitoring device of claim 1, wherein the processor transmits notification including the cleaning area and the cleaning type to a mobile terminal of a user through the communication processor.

9. A method of operating an artificial intelligence monitoring device, the method comprising:
determining whether a floor situation is a situation in which cleaning is required based on an image or cleaning information,
determining a cleaning area and a cleaning type upon determining that cleaning is required, and
transmitting a cleaning command including the determined cleaning area and cleaning type to an artificial intelligence cleaner.

10. The method of claim 9, wherein the determining of whether cleaning is required includes determining that the floor situation is a situation in which cleaning is required, when a name of an object identified through an image recognition model for identifying the object from the image and a state type of the object match a predetermined name and state type.

11. The method of claim 9, wherein the cleaning information includes a usage history of the artificial intelligence cleaner, and
wherein the determining of whether cleaning is required includes determining that the floor situation is a situation in which cleaning is required, when the artificial intelligence cleaner does not operate for a predetermined time or more.

12. The method of claim 9, wherein the cleaning information includes a movement path of the artificial intelligence cleaner, and
wherein the determining of whether cleaning is required includes determining that the floor situation is a situation in which cleaning is required, when there is a cleaning area, in which a cleaning performance degree of the artificial intelligence cleaner which has performed cleaning along a predetermined movement path is less than a predetermined performance degree, based on the movement path among a plurality of cleaning areas.

13. The method of claim 10, wherein the cleaning type includes one or more of a mopping type or a dust suction type.

14. The method of claim 13, wherein the determining of the cleaning area and the cleaning type includes:
determining that the cleaning type is a mapping type when the state type of the object is a liquid type, and
determining that the cleaning type is a dust suction type when the state type of the object is a solid type.

15. The method of claim 9, wherein the cleaning command is a command for moving the artificial intelligence cleaner to the cleaning area to perform cleaning according to the determined cleaning type.

16. The method of claim 9, further comprising transmitting notification including the cleaning area and the cleaning type to a mobile terminal of a user.
